(19) United States
(12) Patent Application Publication
(10) Pub. No.: US 2017/0116620 A1
(43) Pub. Date: Apr. 27, 2017

(54) SYSTEMS AND METHODS FOR IDENTIFYING SPREE SHOPPING BEHAVIOR

(71) Applicant: MasterCard International Incorporated, Purchase, NY (US)

(72) Inventors: Kenny Unser, Fairfield, CT (US); Edward M. Lee, Scarsdale, NY (US)

(21) Appl. No.: 14/921,550

(22) Filed: Oct. 23, 2015

(51) Int. Cl. G06Q 30/02

(52) U.S. Cl. CPC G06Q 30/0201

(57) ABSTRACT

A computer-implemented method for identifying cardholder spree shopping behavior is implemented by a spree shopping identification (SSI) computing device in communication with a memory. The method includes receiving historical transaction data from a payment processor and generating at least one shopping profile using at least a portion of the historical transaction data. The shopping profiles include at least one leading indicator used to identify transaction characteristics consistent with spree shopping behavior. The method further includes receiving current transaction data, applying the shopping profiles to the current transaction data, and determining that a candidate cardholder is engaged in spree shopping behaviors.

### BACKGROUND OF THE DISCLOSURE

The field of the disclosure relates generally to improving merchant merchandising decisions, and more specifically to methods and systems for identifying spree shopping behavior exhibited by a consumer.

A type of shopping behavior known as “spree shopping” includes a series of related transactions over a period of time. At least one known example of spree shopping includes a consumer that begins a home improvement project who proceeds to make several different transactions at a hardware store during the project. In another example of spree shopping, another consumer begins a seasonal clothes shopping spree by making multiple purchases with different apparel merchants that includes several returns before finalizing his or her seasonal wardrobe.

The ability to identify spree shopping enables a merchant to attract consumers with spree shopping behaviors, forecast the merchant's revenue, determine the value of a consumer, and/or make assessments of the merchant's return policy. In at least some known systems, spree shopping behavior in consumers is only recognized and/or analyzed after or near the end of the consumer's spree shopping. Obviously, such known systems have significant limitations. Analyzing the spree shopping behavior of a consumer only after the spree shopping is finished reduces the merchant's ability to react to the consumer's shopping behavior, such as targeting advertisements or offers to such spree shoppers. What is really needed, is a system configured to identify spree shopping behavior of a consumer at the start of the spree

### BRIEF DESCRIPTION OF THE DISCLOSURE

In one aspect, a computer-implemented method for identifying cardholder spree shopping behavior is implemented by a spree shopping identification (SSI) computing device in communication with a memory is provided. The method includes receiving historical transaction data from a payment processor and generating at least one shopping profile using at least a portion of the historical transaction data. The shopping profiles include at least one leading indicator used to identify transaction characteristics consistent with spree shopping behavior. The method further includes receiving current transaction data, applying the shopping profiles to the current transaction data, and determining that a candidate cardholder is engaged in spree shopping behaviors.

In another aspect, a SSI computing device including a processor in communication with a memory is provided. The processor is configured to receive historical transaction data from a payment processor and generate at least one shopping profile using at least a portion of the historical transaction data. The shopping profiles include at least one leading indicator used to identify transaction characteristics consistent with spree shopping behavior. The processor is further programmed to receive current transaction data, apply the shopping profiles to the current transaction data, and determine that a candidate cardholder is engaged in spree shopping behaviors.

In a further aspect, a computer-readable storage media for identifying cardholder spree shopping behavior is provided. The computer-readable storage media has computer-executable instructions embodied thereon that, when executed by at least one processor, the computer-executable instructions cause the processor to receive historical transaction data from a payment processor and generate at least one shopping profile using at least a portion of the historical transaction data. The shopping profiles include at least one leading indicator used to identify transaction characteristics consistent with spree shopping behavior. The computer-executable instructions further cause the processor to receive current transaction data, apply the shopping profiles to the current transaction data, and determine that a candidate cardholder is engaged in spree shopping behaviors.

### BRIEF DESCRIPTION OF THE DRAWINGS

The figures listed below show example embodiments of the methods and systems described herein.

FIGS. 1-7 show example embodiments of the methods and systems described herein.

FIG. 1 is a schematic diagram illustrating an example multi-party payment card industry system for enabling ordinary payment-by-card transactions in which merchants and card issuers do not necessarily have a one-to-one relationship.

FIG. 2 is an expanded block diagram of an example embodiment of server architecture used in payment transactions in accordance with one example embodiment of the present disclosure.

FIG. 3 illustrates an is an expanded block diagram of an example embodiment of a computer server system architecture of a system used to identify cardholder spree shopping behavior in accordance with one example embodiment of the present disclosure.

FIG. 4 illustrates an example configuration of a server system such as the spree shopping identification computer system of FIGS. 2 and 3 used to identify cardholder spree shopping behavior in accordance with one example embodiment of the present disclosure.

FIG. 5 is a simplified data flow diagram of identifying cardholder spree shopping behavior using the systems of FIGS. 2, 3, and 4.

FIG. 6 is a simplified diagram of an example method of identifying cardholder spree shopping behavior using the systems of FIGS. 2, 3, and 4.

FIG. 7 is a diagram of components of one or more example computing devices that may be used in the environment shown in FIG. 6.

Although specific features of various embodiments may be shown in some drawings and not in others, this is for convenience only. Any feature of any drawing may be referenced and/or claimed in combination with any feature of any other drawing.

### DETAILED DESCRIPTION OF THE DISCLOSURE

The following detailed description of the embodiments of the disclosure refers to the accompanying drawings. The same reference numbers in different drawings may identify the same or similar elements. Also, the following detailed description does not limit the claims.

The system described herein, which is referred to herein as a “data analytics system”, is configured to identify and forecast spree shopping behavior using transaction data of a cardholder. More specifically, the data analytics system is configured to (i) determine if the transaction data associated with a payment cardholder indicates that the cardholder is spree shopping, and (ii) forecast the cardholder's shopping behavior from historical spree shopping behavior data. The data analytics system includes a spree shopping identification (SSI) computing device in communication with a payment processor. The payment processor is configured to process payment card transactions initiated by a cardholder with a merchant and/or a database that stores data related to the transactions (“transaction data”). The SSI computing device includes a processor in communication with a memory. The SSI computing device is in communication with at least one database for storing information, such as historical spree shopping behavior data of cardholders.

The SSI computing device is configured to receive transaction data, for example, from the payment processor included within a payment processing network or retrieve the transaction data from a database. Transaction data includes such elements as a transaction amount, a description of the purchase made, a merchant identifier, an account identifier (associating the transaction with a consumer or account holder), and a time and date stamp. In some implementations, transaction data may further include additional elements such as a location identifier, which may identify where the transaction was initiated (i.e., a location of the consumer) and/or the location of the merchant.

The SSI computing device is configured to analyze the transaction data and information retrieved from the database to identify spree shopping behavior of a cardholder. The SSI computing device is further configured to generate shopping profiles of the cardholders using the information returned from the database. The shopping profiles can then be stored in the database or other memory associated with the SSI computing device. The shopping profiles include historical transaction data that identifies shopping behaviors of the cardholders including any spree shopping behaviors. The shopping profiles include personal shopping profiles for each cardholder and general shopping profiles for cardholder demographics based on, for example, age, gender, average transaction amount, merchant location, billing zip code, and/or the transaction data. The shopping profiles may include leading indicators that indicate the cardholder may be spree shopping. A leading indicator is a transaction characteristic based on historical transaction data such as a transaction amount, a merchant identifier, and/or a time and date stamp of previous spree shopping of the cardholder or demographic.

To identify spree shopping behavior, the SSI computing device, after creating the shopping profiles, compares the shopping profiles of the cardholder (e.g., the cardholder's personal shopping profile and any general shopping profiles that the cardholder may be associated with) to the transaction data of the cardholder. In some implementations, the SSI computing device detects if the transaction data matches or is substantially similar to any leading indicators of the shopping profiles of the cardholder.

The SSI computing device may compute a spree shopping score based on the comparison of the shopping profiles of the cardholder and the transaction data. In some implementations, the SSI computing device may apply weighting factors to the leading indicators or combinations of the leading indicators. For example, the time of year may have a greater impact on determining a cardholder is spree shopping than the transaction amount. In another example, a cardholder may not be identified as spree shopping at a merchant until the cardholder spends above a certain amount. The SSI computing device compares the spree shopping score to a threshold value and determines if the cardholder is likely spree shopping. In some implementations, the threshold value is a pre-defined value. In other implementations, the threshold value is generated based on the shopping profiles of the cardholder.

In some implementations, if the SSI computing device identifies spree shopping behavior, the SSI computing device may transmit an alert notification to one or more merchant computing devices associated with a merchant. The alert notification may include, for example, a cardholder identifier and the spree shopping behavior of the cardholder (e.g., where the cardholder shops, how often does the cardholder returns purchases, etc.). The merchant computing devices may include, for example, a point-of-sale (POS) terminal and a server computing device. The POS terminal may be configured to receive the alert notification while the cardholder is making a purchase and provide discounts and other offers to the cardholder for the current or future purchases. The server computing device may be configured to target advertisements to the cardholder and/or store the alert notification for the merchant to analyze.

In some implementations, the shopping profiles of the cardholder are updated based on the transaction data and/or other shopping profiles. For example, if spree shopping behavior of a cardholder is identified by a leading indicator of a general shopping profile and not the cardholder's personal shopping profile, the cardholder's personal shopping profile may be updated by the SSI computing device to include the leading indicator. In another example, the transaction data is combined with the historical transaction data of the shopping profiles for future transactions.

In one example implementation, a cardholder is engaged in a home decorating project. Past transaction activity (i.e., the cardholder's shopping profile) suggests that the cardholder has not visited a home decorating merchant in over a year and the last time the cardholder did visit a home decorating merchant, the cardholder made five follow-up visits to the same merchant over the course of two weeks. During the follow-up visits, the cardholder always made returns. In four of the five follow up visits to the merchant, the cardholder made additional purchases in addition to the returns. The shopping profile of the cardholder indicates the cardholder has three similar spree shopping behaviors in the home decorating category with a frequency of approximately once every 1.5 years. During the shopping sprees, the cardholder visits multiple home decorating merchants.

When the cardholder makes a visit to a home decorating merchant and makes a purchase at a POS terminal that matches a leading indicator, the SSI computing device determines that the cardholder may be starting a shopping spree. The database of shopping profiles is updated with the current purchase, including the matching leading indicator and any new leading indicators. In addition, the shopping profile database records the forecast that the cardholder is starting a shopping spree. At this point, the SSI computing device generates a confidence score or likelihood that the cardholder is engaged in a shopping spree. In this example, the confidence score may indicate that it is likely that the cardholder is engaged in spree shopping behavior. If the merchant that the cardholder visited is subscribed to spree shopping alerts, the SSI computing device will send an alert to the merchant as the cardholder makes the purchase indicating that the cardholder may be spree shopping. The merchant may then offer the cardholder a coupon at the POS terminal for the cardholder's next visit. The cardholder then makes a second purchase at a different home decorating merchant that does not subscribe to spree shopping alerts. The shopping profile database is updated and the SSI computing device recalculates the confidence score to show that the cardholder has a higher likelihood to be engaged in spree shopping behaviors than the previous confidence score indicated. A third home decorating merchant may request a list of cardholders for a prospect mailing list. The SSI computing device generates a relevancy score for the cardholder based at least in part on the spree shopping behavior of the cardholder. The score indicates the cardholder is in a top or relevant tier to the third merchant's mailing list.

In another example implementation, a cardholder engages in a home improvement project such as finishing a basement in the cardholder's home. Similar to the previous example implementation, the cardholder's shopping profile indicates periods of inactivity at home improvement merchants followed by several visits in rapid succession. In a typical shopping spree, the cardholder makes visits to several brick and mortar home improvement stores where the cardholder buys a number of different sizes and colors of items and returns the vast majority of the items the cardholder purchases. The cardholder also makes several online purchases in the home improvement category with a very low return rate. The SSI computing device determines the cardholder is engaged in spree shopping behavior. A customer analysis for a brick and mortar merchant reveals that the merchant has many customers similar to the cardholder that appear to be “showrooming” the merchant's store (i.e., buying items, testing the items, returning the items, and then purchasing the items online). The customer analysis is used as a factor in calculating the lifetime value of the merchant's customers. The home improvement merchant builds a custom model using data received from the SSI computing device that helps the merchant evaluate the benefit of spree shopping related to the merchant. As a result, the home improvement merchant adjusts a return policy of the brick and mortar store and employs a more sophisticated approach to attract home improvement consumers. The merchant may also adjust the brick and mortar store's inventory or stocking based on the return behavior of the cardholder.

The systems and methods described herein are configured to facilitate (a) reduced time to identify spree shopping behaviors; (b) proactive business strategies for merchant to capitalize on spree shopping behavior such as offers to a spree shopping or changing merchant policies; and (c) improved forecasting of business metrics based on spree shopping data.

The technical effects of the systems and methods described herein can be achieved by performing at least one of the following steps: (i) receiving historical transaction data from a payment processor; (ii) generating at least one shopping profile using at least a portion of the historical transaction data, the at least one shopping profile including at least one leading indicator used to identify transaction characteristics consistent with spree shopping behavior; (iii) receiving current transaction data; (iv) applying the at least one shopping profile to the current transaction data; and (v) determining if a candidate cardholder is engaged in spree shopping behaviors.

The following detailed description of the embodiments of the disclosure refers to the accompanying drawings. The same reference numbers in different drawings may identify the same or similar elements. Also, the following detailed description does not limit the claims.

In situations in which the systems discussed herein collect personal information about users, or may make use of personal information, the users may be provided with an opportunity to control whether programs or features collect user information. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as a city, a ZIP code, or state level), so that a particular location of a user cannot be determined Thus, the user may have control over how information is collected about the user and used by the systems.

Described herein are computer systems such as SSI computing devices and user computer systems. As described herein, all such computer systems include a processor and a memory. However, any processor in a computer device referred to herein may also refer to one or more processors wherein the processor may be in one computing device or a plurality of computing devices acting in parallel. Additionally, any memory in a computer device referred to herein may also refer to one or more memories wherein the memories may be in one computing device or a plurality of computing devices acting in parallel.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object oriented databases, and any other structured collection of records or data that is stored in a computer system. The above examples are example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

In one embodiment, a computer program is provided, and the program is embodied on a computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, and/or computers. Each type of transactions card can be used as a method of payment for performing a transaction. In addition, consumer card account behavior can include but is not limited to purchases, management activities (e.g., balance checking), bill payments, achievement of targets (meeting account balance goals, paying bills on time), and/or product registrations (e.g., mobile application downloads).

The systems and processes are not limited to the specific embodiments described herein. In addition, components of each system and each process can be practiced independent and separate from other components and processes described herein. Each component and process also can be used in combination with other assembly packages and processes.

The following detailed description illustrates embodiments of the disclosure by way of example and not by way of limitation. It is contemplated that the disclosure has general application to the determination and analysis of characteristics of devices used in payment transactions.

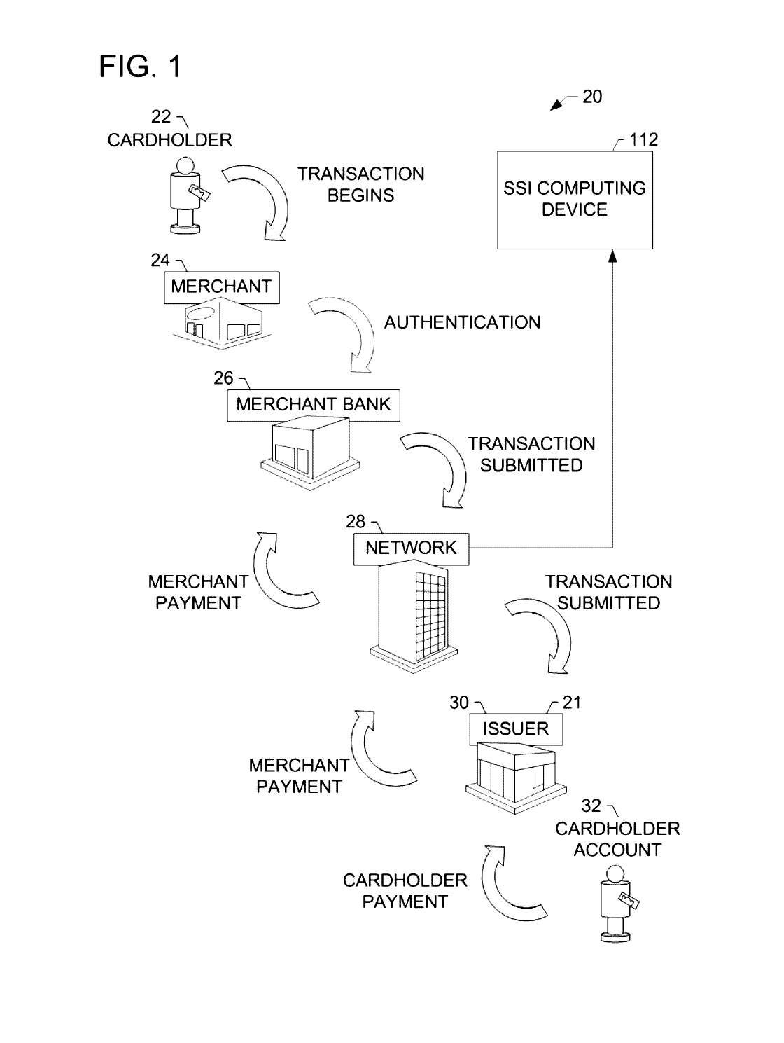

FIG. 1 is a schematic diagram illustrating an example multi-party transaction card industry system 20 for enabling ordinary payment-by-card transactions, including payment-by-card transactions made by cardholders using cardholder computing devices to initiate transactions at an online merchant, in which merchants 24 and card issuers 30 do not need to have a one-to-one special relationship. Typical financial transaction institutions provide a suite of interactive, online applications to both current and prospective customers. For example, a financial transactions institution may have a set of applications that provide informational and sales information on their products and services to prospective customers, as well as another set of applications that provide account access for existing cardholders.

Embodiments described herein may relate to a transaction card system, such as a credit card payment system using the MasterCard® interchange network. The MasterCard® interchange network is a set of proprietary communications standards promulgated by MasterCard International Incorporated® for the exchange of financial transaction data and the settlement of funds between financial institutions that are members of MasterCard International Incorporated®. (MasterCard is a registered trademark of MasterCard International Incorporated located in Purchase, N.Y.).

In a typical transaction card system, a financial institution called the “issuer” issues a transaction card, such as a credit card, to a consumer or cardholder 22, who uses the transaction card to tender payment for a purchase from a merchant 24. Cardholder 22 may purchase goods and services (“products”) at merchant 24. Cardholder 22 may make such purchases using virtual forms of the transaction card and, more specifically, by providing data related to the transaction card (e.g., the transaction card number, expiration date, associated postal code, and security code) to initiate transactions. To accept payment with the transaction card or virtual forms of the transaction card, merchant 24 must normally establish an account with a financial institution that is part of the financial payment system. This financial institution is usually called the “merchant bank,” the “acquiring bank,” or the “acquirer.” When cardholder 22 tenders payment for a purchase with a transaction card or virtual transaction card, merchant 24 requests authorization from a merchant bank 26 for the amount of the purchase. The request may be performed over the telephone or electronically, but is usually performed through the use of a point-of-sale terminal, which reads cardholder's 22 account information from a magnetic stripe, a chip, or embossed characters on the transaction card and communicates electronically with the transaction processing computers of merchant bank 26. Merchant 24 receives cardholder's 22 account information as provided by cardholder 22. Alternatively, merchant bank 26 may authorize a third party to perform transaction processing on its behalf In this case, the point-of-sale terminal will be configured to communicate with the third party. Such a third party is usually called a “merchant processor,” an “acquiring processor,” or a “third party processor.”

Using an interchange network 28, computers of merchant bank 26 or merchant processor will communicate with computers of an issuer bank 30 to determine whether cardholder's 22 account 32 is in good standing and whether the purchase is covered by cardholder's 22 available credit line. Based on these determinations, the request for authorization will be declined or accepted. If the request is accepted, an authorization code is issued to merchant 24.

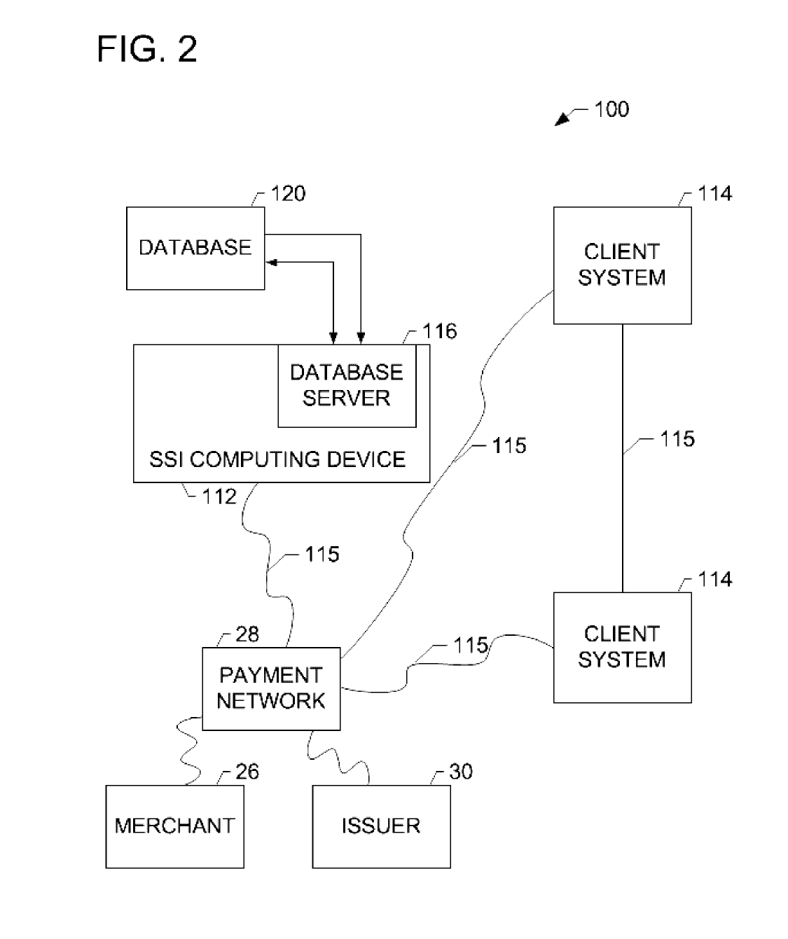

When a request for authorization is accepted, the available credit line of cardholder's 22 account 32 is decreased. Normally, a charge for a payment card transaction is not posted immediately to cardholder's 22 account 32 because bankcard associations, such as MasterCard International Incorporated®, have promulgated rules that do not allow merchant 24 to charge, or “capture,” a transaction until products are shipped or services are delivered. However, with respect to at least some debit card transactions, a charge may be posted at the time of the transaction. When merchant 24 ships or delivers the products or services, merchant 24 captures the transaction by, for example, appropriate data entry procedures on the point-of-sale terminal This may include bundling of approved transactions daily for standard retail purchases. If cardholder 22 cancels a transaction before it is captured, a “void” is generated. If cardholder 22 returns products after the transaction has been captured, a “credit” is generated. Interchange network 28 and/or issuer bank 30 stores the transaction card information, such as a type of merchant, amount of purchase, date of purchase, in a database 120 (shown in FIG. 2).

After a purchase has been made, a clearing process occurs to transfer additional transaction data related to the purchase among the parties to the transaction, such as merchant bank 26, interchange network 28, and issuer bank 30. More specifically, during and/or after the clearing process, additional data, such as a time of purchase, a merchant name, a type of merchant, purchase information, cardholder account information, a type of transaction, information regarding the purchased item and/or service, and/or other suitable information, is associated with a transaction and transmitted between parties to the transaction as transaction data, and may be stored by any of the parties to the transaction. In the example embodiment, transaction data including such additional transaction data may also be provided to systems including spree shopping identification (SSI) computing device 112. In the example embodiment, interchange network 28 provides such transaction data and additional transaction data such as historical transaction data. In alternative embodiments, any party may provide such transaction data and historical transaction data to SSI computing device 112.

After a transaction is authorized and cleared, the transaction is settled among merchant 24, merchant bank 26, and issuer bank 30. Settlement refers to the transfer of financial data or funds among merchant's 24 account, merchant bank 26, and issuer bank 30 related to the transaction. Usually, transactions are captured and accumulated into a “batch,” which is settled as a group. More specifically, a transaction is typically settled between issuer bank 30 and interchange network 28, and then between interchange network 28 and merchant bank 26, and then between merchant bank 26 and merchant 24.

As described below in more detail, SSI computing device 112 may be used to identify spree shopping behavior and alert merchants such as merchant 24 using transaction data and historical transaction data received from, for example, interchange network 28. Although the systems described herein are not intended to be limited to facilitate such applications, the systems are described as such for exemplary purposes.

FIG. 2 is a simplified block diagram of an example computer system 100 used to identify cardholder spree shopping behavior in accordance with the present disclosure. In the example embodiment, system 100 is configured to receive historical transaction data, generate a shopping profile using at least a portion of the historical transaction data, where the shopping profile includes at least one leading indicator used to identify transaction characteristics consistent with spree shopping behavior, receive current transaction data, apply the shopping profile to the current transaction data, and determine if a candidate cardholder is beginning to engage in spree shopping behaviors, as described herein. In other embodiments, the applications may reside on other computing devices (not shown) communicatively coupled to system 100, and may identify spree shopping behavior using system 100.

More specifically, in the example embodiment, system 100 includes an SSI computing device 112, and a plurality of client sub-systems, also referred to as client systems 114, connected to SSI computing device 112. In one embodiment, client systems 114 are computers including a web browser, such that SSI computing device 112 is accessible to client systems 114 using the Internet. Client systems 114 are interconnected to the Internet through many interfaces including a network 115, such as a local area network (LAN) or a wide area network (WAN), dial-in-connections, cable modems, special high-speed Integrated Services Digital Network (ISDN) lines, and RDT networks. Client systems 114 may include systems associated with cardholders 22 (shown in FIG. 1) as well as external systems used to store review data (“external review resources”). SSI computing device system 112 is also in communication with payment network 28 using network 115. Further, client systems 114 may additionally communicate with payment network 28 using network 115. Client systems 114 could be any device capable of interconnecting to the Internet including a web-based phone, PDA, or other web-based connectable equipment.

A database server 116 is connected to database 120, which contains information on a variety of matters, as described below in greater detail. In one embodiment, centralized database 120 is stored on SSI computing device 112 and can be accessed by potential users at one of client systems 114 by logging onto SSI computing device 112 through one of client systems 114. In an alternative embodiment, database 120 is stored remotely from SSI computing device 112 and may be non-centralized.

Database 120 may include a single database having separated sections or partitions, or may include multiple databases, each being separate from each other. Database 120 may store transaction data generated over the processing network including data relating to merchants, account holders, prospective customers, issuers, acquirers, and/or purchases made. Database 120 may also store account data including at least one of a cardholder name, a cardholder address, an account number, other account identifiers, and transaction information. Database 120 may also store merchant information including a merchant identifier that identifies each merchant registered to use the network, and instructions for settling transactions including merchant bank account information. Database 120 may also store purchase data associated with items being purchased by a cardholder from a merchant, and authorization request data. Further, as described herein, database 120 may contain historical transaction data, transaction data, merchant notification data (e.g., how and when to contact a merchant), shopping profiles, spree shopping behaviors, and leading indicators for shopping profiles.

In the example embodiment, one of client systems 114 may be associated with acquirer bank 26 (shown in FIG. 1) while another one of client systems 114 may be associated with issuer bank 30 (shown in FIG. 1). SSI computing device 112 may be associated with interchange network 28. In the example embodiment, SSI computing device 112 is associated with a network interchange, such as interchange network 28, and may be referred to as an interchange computer system. SSI computing device 112 may be used for processing transaction data. In addition, client systems 114 may include a computer system associated with at least one of an online bank, a bill payment outsourcer, an acquirer bank, an acquirer processor, an issuer bank associated with a transaction card, an issuer processor, a remote payment system, customers and/or billers.

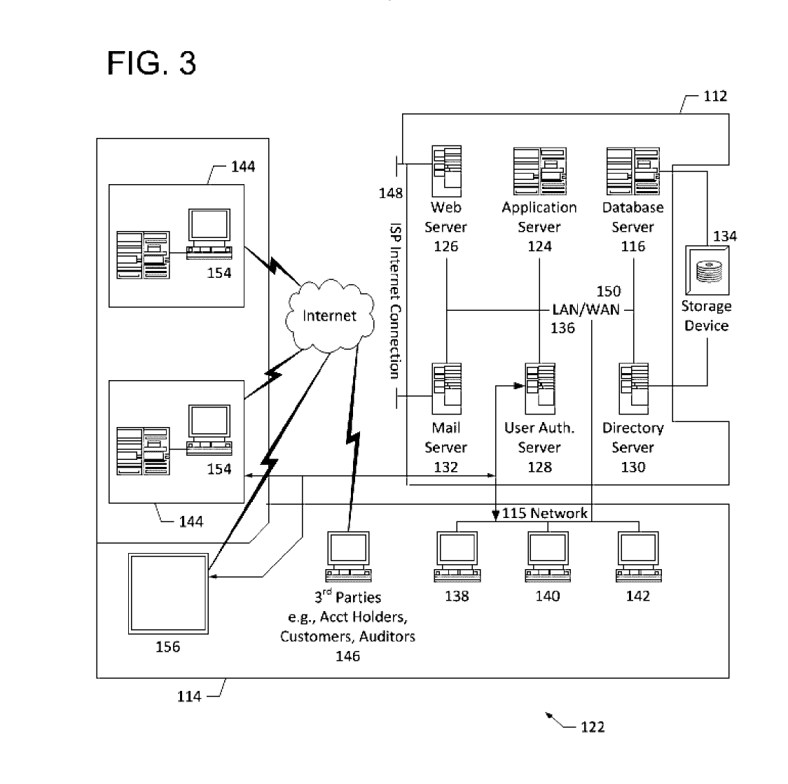

FIG. 3 is an expanded block diagram of an example embodiment of a computer server system architecture of a processing system 122 used to identify spree shopping behavior in accordance with one embodiment of the present disclosure. Components in system 122, identical to components of system 100 (shown in FIG. 2), are identified in FIG. 3 using the same reference numerals as used in FIG. 2. System 122 includes SSI computing device 112, client systems 114, and payment systems 118. SSI computing device 112 further includes database server 116, a transaction server 124, a web server 126, a user authentication server 128, a directory server 130, and a mail server 132. A storage device 134 is coupled to database server 116 and directory server 130. Servers 116, 124, 126, 128, 130, and 132 are coupled in a local area network (LAN) 136. In addition, an issuer bank workstation 138, an acquirer bank workstation 140, and a third party processor workstation 142 may be coupled to LAN 136. In the example embodiment, issuer bank workstation 138, acquirer bank workstation 140, and third party processor workstation 142 are coupled to LAN 136 using network connection 115. Workstations 138, 140, and 142 are coupled to LAN 136 using an Internet link or are connected through an Intranet.

Each workstation 138, 140, and 142 is a personal computer having a web browser. Although the functions performed at the workstations typically are illustrated as being performed at respective workstations 138, 140, and 142, such functions can be performed at one of many personal computers coupled to LAN 136. Workstations 138, 140, and 142 are illustrated as being associated with separate functions only to facilitate an understanding of the different types of functions that can be performed by individuals having access to LAN 136.

SSI computing device 112 is configured to be operated by various individuals including employees 144 and to third parties, e.g., account holders, customers, auditors, developers, consumers, merchants, acquirers, issuers, etc., 146 using an ISP Internet connection 148. The communication in the example embodiment is illustrated as being performed using the Internet, however, any other wide area network (WAN) type communication can be utilized in other embodiments, i.e., the systems and processes are not limited to being practiced using the Internet. In addition, and rather than WAN 150, local area network 136 could be used in place of WAN 150. SSI computing device 112 is also configured to be communicatively coupled to payment systems 118. Payment systems 118 include computer systems associated with merchant bank 26, interchange network 28, issuer bank 30 (all shown in FIG. 1), and interchange network 28. Additionally, payments systems 118 may include computer systems associated with acquirer banks and processing banks. Accordingly, payment systems 118 are configured to communicate with SSI computing device 112 and provide transaction data as discussed below.

In the example embodiment, any authorized individual having a workstation 154 can access system 122. At least one of the client systems includes a manager workstation 156 located at a remote location. Workstations 154 and 156 are personal computers having a web browser. Also, workstations 154 and 156 are configured to communicate with SSI computing device 112.

Also, in the example embodiment, web server 126, application server 124, database server 116, and/or directory server 130 may host web applications, and may run on multiple SSI computing devices 112. The term “suite of applications,” as used herein, refers generally to these various web applications running on SSI computing devices 112.

Furthermore, user authentication server 128 is configured, in the example embodiment, to provide user authentication services for the suite of applications hosted by web server 126, application server 124, database server 116, and/or directory server 130. User authentication server 128 may communicate with remotely located client systems, including a client system 156. User authentication server 128 may be configured to communicate with other client systems 138, 140, and 142 as well.

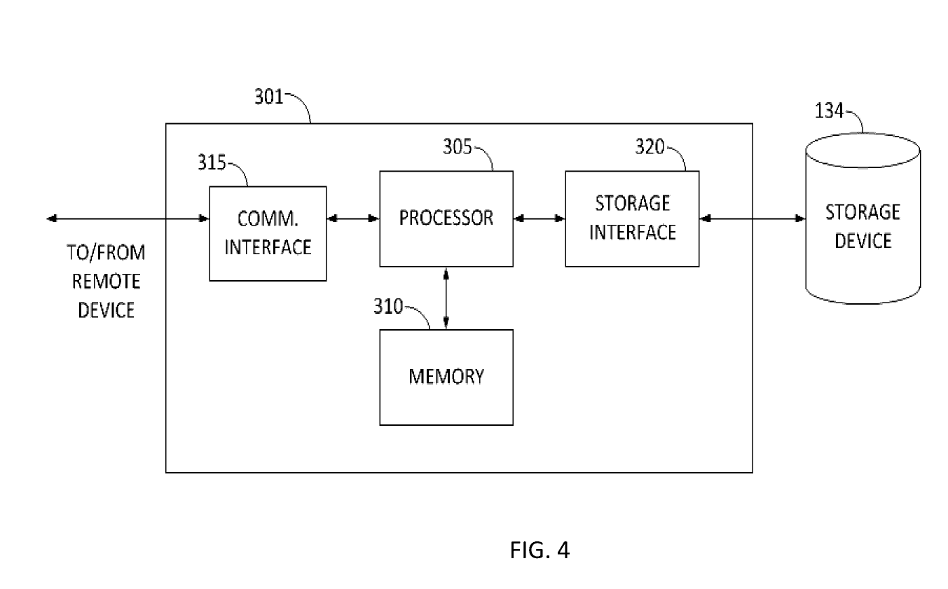

FIG. 4 illustrates an example configuration of a server system 301 such as SSI computing device 112 (shown in FIGS. 2 and 3). Server system 301 may include, but is not limited to, database server 116, transaction server 124, web server 126, user authentication server 128, directory server 130, and mail server 132. In the example embodiment, server system 301 determines and analyzes characteristics of devices used in payment transactions, as described below.

Server system 301 includes a processor 305 for executing instructions. Instructions may be stored in a memory area 310, for example. Processor 305 may include one or more processing units (e.g., in a multi-core configuration) for executing instructions. The instructions may be executed within a variety of different operating systems on the server system 301, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 305 is operatively coupled to a communication interface 315 such that server system 301 is capable of communicating with a remote device such as a user system or another server system 301. For example, communication interface 315 may receive requests from user system 114 via the Internet, as illustrated in FIGS. 2 and 3.

Processor 305 may also be operatively coupled to a storage device 134. Storage device 134 is any computer-operated hardware suitable for storing and/or retrieving data. In some embodiments, storage device 134 is integrated in server system 301. For example, server system 301 may include one or more hard disk drives as storage device 134. In other embodiments, storage device 134 is external to server system 301 and may be accessed by a plurality of server systems 301. For example, storage device 134 may include multiple storage units such as hard disks or solid state disks in a redundant array of inexpensive disks (RAID) configuration. Storage device 134 may include a storage area network (SAN) and/or a network attached storage (NAS) system.

In some embodiments, processor 305 is operatively coupled to storage device 134 via a storage interface 320. Storage interface 320 is any component capable of providing processor 305 with access to storage device 134. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 134.

Memory area 310 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

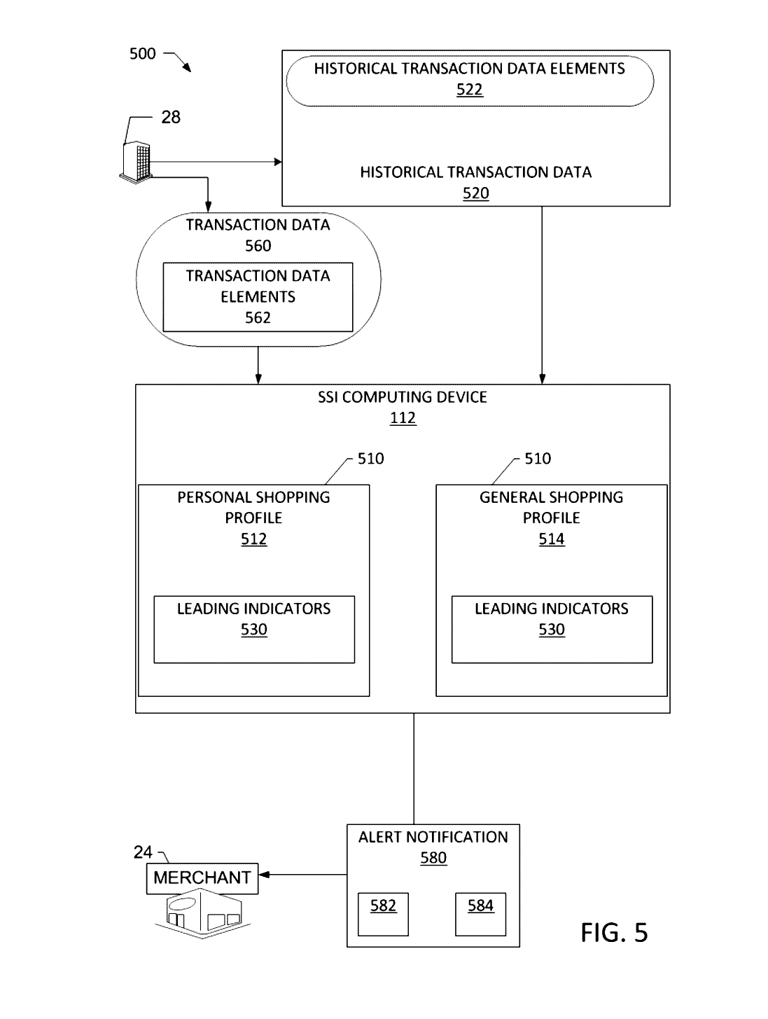

FIG. 5 is a simplified data flow diagram 500 of identifying spree shopping behavior using SSI computing device 112 of FIGS. 2, 3, and 4. SSI computing device 112 generates shopping profiles 510 that include shopping behaviors of cardholders, e.g., spree shopping behaviors, by analyzing historical transaction data 520. Historical transaction data 520 represents previously processed transaction data from previous consumer transactions. In at least one example, historical transaction data may be stored at a transaction data database 120 (shown in FIG. 2) associated with SSI computing device 112. In alternative examples, historical transaction data 520 may be stored at other systems or received from a payment network computer system associated with payment network 28.

SSI computing device 112 receives historical transaction data 520 associated with a plurality of historical transactions. Such historical transaction data 520 may be associated with a plurality of cardholders and a plurality of merchants. In some embodiments, historical transaction data 520 may be associated with one cardholder. The historical transaction data may include elements 522 including transaction amounts, transaction volumes, transaction categories, product identifiers, transaction location, cardholder residence location, merchant location, transaction date and time, merchant identifiers, and cardholder numbers.

However, in some examples, received historical transaction data 520 may not include all such elements 522 and SSI computing device 112 may infer elements 522. For example, historical transaction data 520 may not include cardholder residence location. SSI computing device 112 may process historical transaction data 520 to predict a likely cardholder residence location based on merchant locations for historical transaction data associated with the cardholder. Similarly, not all historical transaction data 520 includes transaction categories. However, transaction categories may be determined based on merchant identifiers. For example, a merchant identifier “ABC” associated with a hardware store may be identified by SSI computing device 112. SSI computing device 112 may determine that historical transaction data 520 with a merchant identifier of “ABC” may have a transaction category of “Hardware”.

SSI computing device 112 processes such historical transaction data 520 to generate shopping profiles 510. Once generated, shopping profiles 510 are stored within a memory associated with SSI computing device 112 (e.g., database 120 shown in FIG. 1) for further analysis. As described herein, shopping profiles 510 may include a personal shopping profile 512 and/or a general shopping profile 514. Shopping profiles 510 may include leading indicators 530. Leading indicators 530 are transaction characteristics, e.g., elements 522, of transaction data (including current transaction data 560 or historical transaction data 520) that indicate a cardholder may be spree shopping. In some embodiments, leading indicators 530 may anticipate the cardholder's spree shopping. Leading indicators 530 are associated with spree shopping behaviors and characteristics stored in shopping profiles 510. Such leading indicators 530 vary in type. Leading indicators 530 may include, for example, and without limitation, transaction amounts, transaction volumes, distance traveled for purchase, frequency of purchase, transaction categories, product identifiers, transaction location, cardholder residence location, merchant location, transaction date and time, merchant identifiers, and cardholder numbers that indicate spree shopping behaviors. Leading indicators 530 may be specific values or ranges of values. In some embodiments, leading indicators 530 may be a combination of transaction characteristics. For example, one leading indicator 530 of a cardholder may include the combination of the cardholder making a purchase at a toy department store and the purchase occurring during winter. During previous shopping sprees, the cardholder then makes a plurality of purchases and returns through winter.

Further, although many shopping profiles 510 are determined to include leading indicators 530 based on averages from historical transaction data 520, other shopping profiles 510 may use additional mathematical models to determine such leading indicators 530. Any suitable statistical or mathematical model may be used to determine such leading indicators 530.

In at least some examples, a cardholder withdrawing money from a financial account may indicate spree shopping. Therefore, in at least some examples, some shopping profiles 510 are generated to include leading indicators 530 associated with the withdrawal of money from a financial account or any other transactions associated with a financial account.

The spree shopping behaviors included in shopping profiles 510 provide information to merchants that enable the merchants to anticipate and/or react to the potential spree shopping cardholder before the spree shopping has concluded. The spree shopping behaviors may indicate, for example, a category of purchases (e.g, garden, home improvement, etc.), a number of purchases, visits, coupons used, and/or returns, transaction amounts, and duration of spree shopping. Each spree shopping behavior in shopping profiles 510 may be associated with a leading indicator such as leading indicator 530. Some spree shopping behaviors may not be associated with a leading indicator. Such behaviors may appear to be random.

Shopping profiles 510 are updated based on current transaction data 560 and/or other shopping profiles 510. In one example, a leading indicator 530 of a first shopping profile 510 used to successfully identify spree shopping behaviors may be added to a second shopping profile 510 for future analysis. In another example, SSI computing device 112 may identify a new leading indicator 530 within current transaction data 560 and update shopping profiles 510 with the new leading indicator 530.

In the example embodiment, personal shopping profiles 512 are based on an individual cardholder's historical transaction data 520. Leading indicators 530 in personal shopping profile 512 of a candidate cardholder may indicate spree shopping behaviors associated with the candidate cardholder. Personal shopping profile 512 may be updated based on current transaction data 560. In the example embodiment, personal shopping profiles 512 do not include a leading indicator until spree shopping behaviors of the candidate cardholder are identified. In certain embodiments, personal shopping profile 512 of the candidate cardholder may be generated based on aggregated historical transaction data 520 from a group (e.g., two to five) of cardholders including the candidate cardholder. The group may include cardholders with substantially similar historical transaction data 520, leading indicators 530, and/or current transaction data 560 such that personal shopping profile 512 remains indicative of the candidate cardholder's spree shopping behaviors.

General shopping profiles 514 are generated based on historical transaction data 520 of a plurality of cardholders. The plurality of cardholders may be grouped to form general shopping profiles 514 based on a characteristic of the cardholders, such as, but not limited to, age, salary, home address, shopping behaviors, and average amount spent. A candidate cardholder that shares the characteristic may be associated with a general shopping profile 514. As such, the candidate cardholder may be associated with more than one general shopping profile 514. General shopping profile 514 may include leading indicators 530 aggregated from at least a portion the plurality of cardholders and/or separate leading indicators 530 for each cardholder. General shopping profile 514 enables SSI computing device 112 to identify more leading indicators 530 for the candidate cardholder using transaction data from similar cardholders. Leading indicators 530 of general shopping profile 514 may enable SSI computing device 112 to identify new spree shopping behaviors of the candidate cardholder. For example, a cardholder that has recently received a salary raise may alter his or her shopping behaviors (including spree shopping behaviors) to adjust with the salary raise. A general shopping profile 514 may be associated with the new salary of the cardholder and may include leading indicators 530 that fit the cardholder's new shopping behaviors.

To identify potential spree shopping of a candidate cardholder, SSI computing device 112 is configured to analyze current transaction data 560 and the generated shopping profiles 510. SSI computing device 112 compares current transaction data 560 of the candidate cardholder to shopping profiles 510 of the cardholder. In particular, SSI computing device 112 is configured to detect current transaction data 560 of the cardholder that matches or is substantially similar to one or more leading indicators 530 of the cardholder's shopping profiles 510. Current transaction data 560 that matches one or more leading indicators 530 indicates that the candidate cardholder may be spree shopping.

In at least some embodiments, SSI computing device 112 computes one or more spree shopping scores based on the analysis of current transaction data 560 and the generated shopping profiles 510. The spree shopping scores may indicate if the cardholder is likely spree shopping. Each spree shopping score may be associated with one or more transaction data elements (e.g., leading indicators 530) of historical transaction data 520 and/or current transaction data 560. In certain embodiments, SSI computing device 112 may apply weighting factors to leading indicators 530 or combinations of leading indicators 530. In one example, SSI computing device may weight or prioritize leading indicators 530 of personal shopping profile 512 over leading indicators 530 of general shopping profile 514. In certain embodiments, SSI computing device 112 may ignore leading indicators 530 of general shopping profile 514 if personal shopping profile 512 includes one or more leading indicators 530. SSI computing device 112 may compare the spree shopping scores to one or more threshold values to determine if the cardholder is likely spree shopping. In the example embodiment, the threshold value is a pre-defined value. In other embodiments, the threshold value is generated based on shopping profiles 510 of the cardholder.

In the example embodiment, SSI computing device 112 is configured to transmit an alert notification 580 to each merchant 24 subscribed to receive notifications related to relevant spree shopping behavior. For example, a home improvement store may subscribe to SSI computing device 112 to receive alert notification 580 for spree shopping behavior related to home improvement projects near merchant 24. Alert notification 580 may be associated with one or more cardholders engaged in spree shopping behavior. Alert notification 580 includes cardholder information 582. Cardholder information 582 identifies a cardholder associated with alert notification 580 and indicates one or more spree shopping behaviors of the cardholder. Cardholder information 582 may include contact information of the cardholder such as an email address of the cardholder to enable merchant 24 to send discounts and offers to the cardholder. In some embodiments, cardholder information 582 may include at least a portion of one or more shopping profiles 510. Cardholder information 582 enables merchants 24 that receive alert notification 580 to anticipate (or respond to) specific spree shopping behaviors of the cardholder.

In at least some embodiments, alert notification 580 may further include a confidence indicator 584. Confidence indicator 584 is configured to enable merchant 24 to assess the likelihood that the cardholder is engaged in spree shopping. In one example, confidence indicator 584 may be the spree shopping scores or a confidence score based on the spree shopping scores. In another example, confidence indicator 584 may be a tiered for different levels of confidence (e.g., “low likelihood”, “medium likelihood”, and “high likelihood”). In addition to the above examples, confidence indicator 584 may be a different format, include additional or less information, and/or include a combination of indicators (e.g., a spree shopping score and a confidence level tier).

SSI computing device 112 may store a table (not shown) of merchants 24 that have subscribed to receive alert notifications 580. The table may include information such as how to communicate with each merchant 24 and when to transmit alert notifications 580 to each merchant 24. In one embodiment, each merchant 24 provides such information when subscribing. For example, one merchant 24 may indicate one or more computing devices such as a point-of-sale (POS) device or a server computing device to transmit alert notifications 580. Merchant 24 may further indicate that merchant 24 wants to receive alert notifications 580 for cardholders within 25 miles of a location of merchant 24 and engaged in spree shopping behaviors related to clothing with a “high likelihood” confidence indicator 584. SSI computing device 112 automatically transmits alert notification 580 based on the configuration for each merchant 24. In other embodiments, SSI computing device 112 may send alert notification 580 to each subscribed merchant 24.

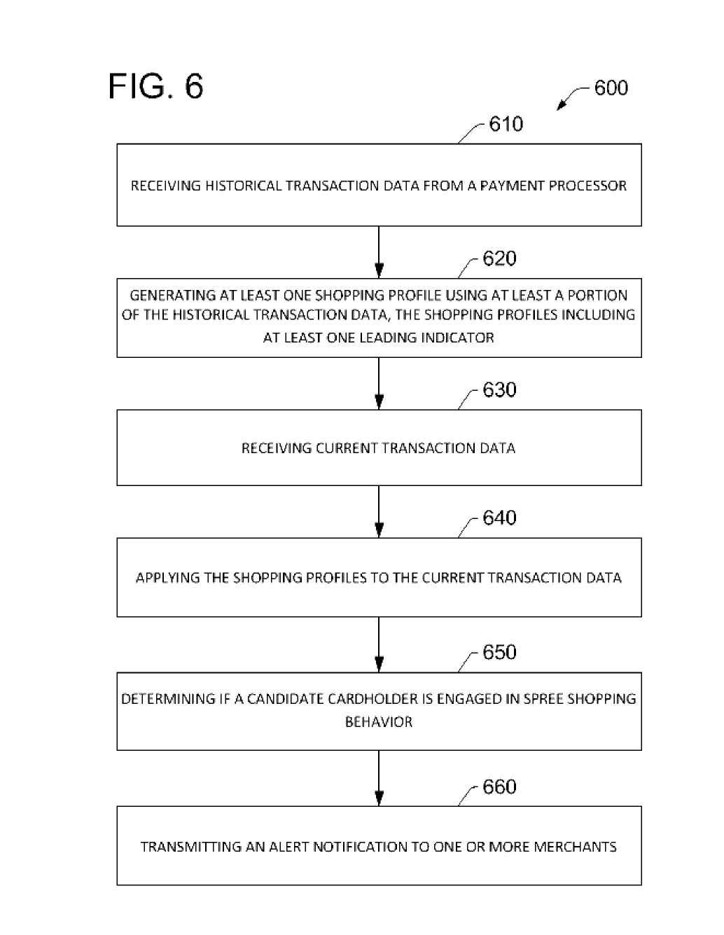

FIG. 6 is a simplified diagram of an example method 600 of identifying spree shopping behavior using SSI computing device 112 (shown in FIGS. 2 and 3). Method 600 is accordingly carried out by SSI computing device 112. SSI computing device 112 receives 610 historical transaction data 520 (shown in FIG. 5) from a payment processor (e.g., payment system 118). In the example embodiment, historical transaction data 520 indicates at least one spree shopping behavior of a candidate cardholder or a group of cardholders that includes the candidate cardholder.

SSI computing device 112 also generates 620 at least one shopping profile 510 using at least a portion of historical transaction data 520. Shopping profiles 510 may include a personal shopping profile 512 and/or a general shopping profile 514 (each shown in FIG. 5). Shopping profiles 510 include one or more leading indicators 530 (shown in FIG. 5) used to identify transaction characteristics or elements consistent with spree shopping behavior. SSI computing device 112 stores shopping profiles 510 for further analysis.

SSI computing device 112 additionally receives 630 current transaction data 560 (shown in FIG. 5) for one or more transactions initiated by the candidate cardholder and applies 640 shopping profiles 510 to current transaction data 560. Applying 640 may include, for example, comparing leading indicators 530 of shopping profiles 510 to transaction characteristics or elements of current transaction data 560. In some embodiments, SSI computing device 112 may identify a portion of current transaction data 560 that substantially matches one leading indicator 530. In certain embodiments with a personal shopping profile 512 and a general shopping profile 514, SSI computing device 112 may prioritize comparing leading indicators 530 from personal shopping profile 512. If personal shopping profile 512 does not include any leading indicators 530, SSI computing device 112 may then compare current transaction data 560 to leading indicators 530 of general shopping profile 514.

SSI computing device 112 additionally determines 650 if the candidate cardholder is engaged or beginning to engage in spree shopping behaviors. In certain embodiments, if SSI computing device 112 identifies a portion of current transaction data 560 that substantially matches one leading indicator 530, SSI computing device 112 determines 650 that the candidate cardholder is engaged in spree shopping behaviors. SSI computing device 112 may generate a spree shopping score based on applying 640 shopping profiles 510 to current transaction data 560. The spree shopping score may be used to determine 650 the candidate cardholder is engaged in spree shopping behavior.

In some embodiments, SSI computing device 112 may transmit 660 an alert notification 580 (shown in FIG. 5) to one or more merchants. The alert notification enables the merchants to anticipate or respond to the candidate cardholder's spree shopping.

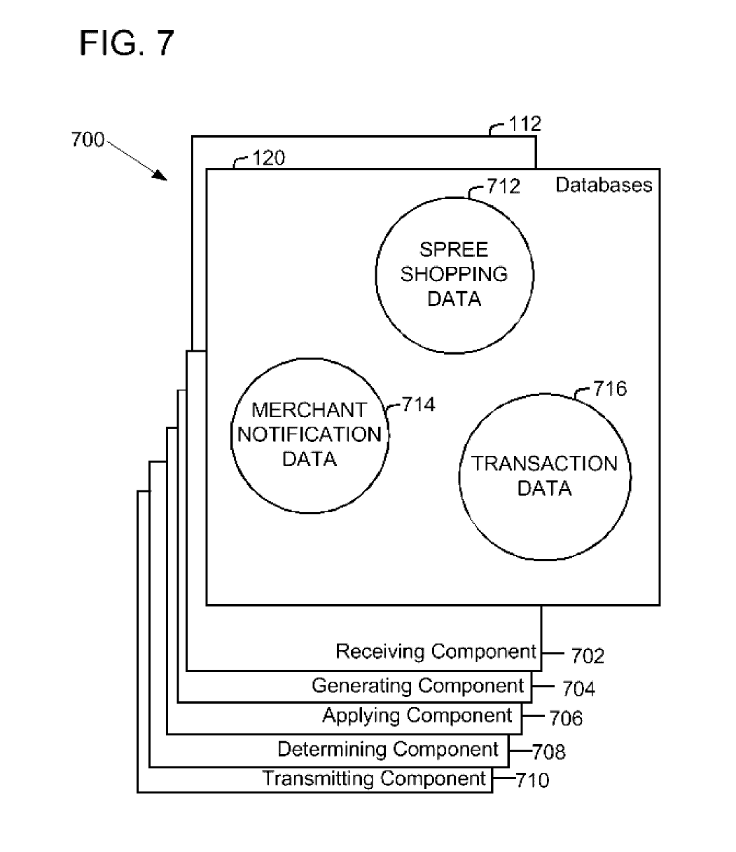

FIG. 7 is a diagram 700 of components of one or more example computing devices that may be used in the environment shown in FIG. 6. FIG. 7 further shows a configuration of databases including at least database 120 (shown in FIG. 1). Database 120 is coupled to several separate components within SSI computing device 112, which perform specific tasks.

SSI computing device 112 includes a receiving component 702 for receiving current and historical transaction data from a payment processor. SSI computing device 112 also includes a generating component 704 for generating one or more shopping profiles associated with a candidate cardholder from the transaction data. Generating component 704 is configured to generate a leading indicator associate with spree shopping behaviors for at least one shopping profile. SSI computing device 112 includes an applying component 706 for applying the shopping profiles to the current transaction data. In particular, applying component 706 applies any leading indicators to transaction elements or characteristics of the current transaction data. SSI computing device 112 additionally includes a determining component 708 that determines if the candidate cardholder is engaged in spree shopping behaviors. In some embodiments, SSI computing device 112 further includes a transmitting component 710 that transmits an alert notification to one or more merchants when SSI computing device 112 determines the candidate cardholder is engaged in spree shopping behaviors.

In an exemplary embodiment, database 120 stores different types of data, including, but not limited to, spree shopping data 712, merchant notification data 714, and transaction data 716. Spree shopping data 712 may include, for example, leading indicators, spree shopping behaviors, and shopping profiles of cardholders. Merchant notification data 714 indicates how and when each merchant receives alert notifications. Transaction data 716 may include historical transaction data and/or aggregated transaction data from a plurality of cardholders. Database 120 is configured to retrieve, transmit, and update each type of data as required.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

This written description uses examples to disclose the disclosure, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A computer-implemented method for identifying spree shopping behavior, the method implemented by a spree shopping identification (SSI) computing device in communication with a memory, the method comprising:
receiving historical transaction data from a payment processor;
generating at least one shopping profile using at least a portion of the historical transaction data, the at least one shopping profile including at least one leading indicator used to identify transaction characteristics consistent with spree shopping behavior;
receiving current transaction data for a transaction initiated by a candidate cardholder;
applying the at least one shopping profile to the current transaction data; and
determining that the candidate cardholder is engaged in spree shopping behaviors.

2. The method of claim 1, wherein applying the at least one shopping profile to the current transaction data further comprises:
comparing the at least one leading indicator to the current transaction data; and
identifying a portion of the current transaction data that substantially matches a first leading indicator of the at least one leading indicator.

3. The method of claim 1, further comprising transmitting an alert notification of the spree shopping behavior of the candidate cardholder to at least one merchant computing device.

4. The method of claim 3, wherein the alert notification comprises a cardholder identifier and at least one of a first portion of the at least one shopping profile and a confidence score that the candidate cardholder is engaged in spree shopping behavior, wherein the first portion includes historical spree shopping characteristics.

5. The method of claim 1, wherein the at least one shopping profile comprises a first cardholder shopping profile and a first general shopping profile.

6. The method of claim 5, wherein the first cardholder shopping profile comprises a first leading indicator specific to the candidate cardholder and the first general shopping profile comprises a second leading indicator specific to a demographic associated with the candidate cardholder, and wherein applying the at least one shopping profile further comprises (i) comparing the first leading indicator to the current transaction data, and (ii) comparing the second leading indicator to the current transaction data.

7. The method of claim 1, wherein determining that a candidate cardholder is engaged in spree shopping behaviors further comprises:
generating a spree shopping score based on comparing the current transaction data to the at least one leading indicator; and
identifying the transaction as being part of spree shopping behavior if the spree shopping score satisfies a threshold value.

8. The method of claim 1, further comprising updating the at least one shopping profile based at least in part on the current transaction data.

9. A spree shopping identification (SSI) computing device including a processor in communication with a memory, said processor configured to:
receive historical transaction data from a payment processor;
generate at least one shopping profile using at least a portion of the historical transaction data, the at least one shopping profile including at least one leading indicator used to identify transaction characteristics consistent with spree shopping behavior;
receive current transaction data for a transaction initiated by a candidate cardholder;
apply the at least one shopping profile to the current transaction data; and
determine that the candidate cardholder is engaged in spree shopping behaviors.

10. The SSI computing device of claim 9, wherein said processor is further configured to:
compare the at least one leading indicator to the current transaction data; and
identify a portion of the current transaction data that substantially matches a first leading indicator of the at least one leading indicator.

11. The SSI computing device of claim 9, wherein said processor is further configured to transmit an alert notification of the spree shopping behavior of the candidate cardholder to at least one merchant computing device.

12. The SSI computing device of claim 11, wherein the alert notification comprises a cardholder identifier and at least one of a first portion of the at least one shopping profile and a confidence score that the candidate cardholder is engaged in spree shopping behavior, wherein the first portion includes historical spree shopping characteristics.

13. The SSI computing device of claim 9, wherein the at least one shopping profile comprises a first cardholder shopping profile and a first general shopping profile.

14. The SSI computing device of claim 13, wherein the first cardholder shopping profile comprises a first leading indicator specific to the candidate cardholder and the first general shopping profile comprises a second leading indicator specific to a demographic associated with the candidate cardholder, and wherein said processor is further configured to (i) compare the first leading indicator to the current transaction data, and (ii) compare the second leading indicator to the current transaction data.

15. The SSI computing device of claim 9, wherein said processor is configured to:
generate a spree shopping score based on comparing the current transaction data to the at least one leading indicator; and
identify the transaction data as being part of spree shopping behavior if the spree shopping score satisfies a threshold value.

16. The SSI computing device of claim 9, wherein said processor is further configured to update the at least one shopping profile based at least in part on the current transaction data.

17. Computer-readable storage media for identifying spree shopping behavior, the computer-readable storage media having computer-executable instructions embodied thereon, wherein, when executed by at least one processor, the computer-executable instructions cause the processor to:
receive historical transaction data from a payment processor;
generate at least one shopping profile using at least a portion of the historical transaction data, the at least one shopping profile including at least one leading indicator used to identify transaction characteristics consistent with spree shopping behavior;
receive current transaction data for a transaction initiated by a candidate cardholder;
apply the at least one shopping profile to the current transaction data; and
determine that the candidate cardholder is engaged in spree shopping behaviors.

18. The computer-readable storage media in accordance with claim 17, wherein the computer-executable instructions cause the processor to:
compare the at least one leading indicator to the current transaction data; and
identify a portion of the current transaction data that substantially matches a first leading indicator of the at least one leading indicator.

19. The computer-readable storage media in accordance with claim 17, wherein the computer-executable instructions cause the processor to:
transmit an alert notification of the spree shopping behavior of the candidate cardholder to at least one merchant computing device, wherein the alert notification comprises a cardholder identifier and at least one of a first portion of the at least one shopping profile and a confidence score that the candidate cardholder is engaged in spree shopping behavior, wherein the first portion includes historical spree shopping characteristics.

20. The computer-readable storage media in accordance with claim 17, wherein the computer-executable instructions cause the processor to:
generate a spree shopping score based on comparing the current transaction data to the at least one leading indicator; and
identify the transaction as being part of spree shopping behavior if the spree shopping score satisfies a threshold value.
